(19) United States
(12) Patent Application Publication
(10) Pub. No.: US 2025/0118453 A1
(43) Pub. Date: Apr. 10, 2025

(54) Time-Orbiting Potential Chip Trap for Cold Atoms

(71) Applicants: Utah State University Space Dynamics Laboratory, North Logan, UT (US); University of Virginia UVA Licensing and Ventures, Charlottesville, VA (US)

(72) Inventors: Charles SACKETT, Charlottesville, VA (US); James STICKNEY, North Logan, UT (US)

(73) Assignees: Utah State University Space Dynamics Laboratory, North Logan, UT (US); University of Virginia UVA Licensing and Ventures, Charlottesville, VA (US)

(21) Appl. No.: 18/482,737

(22) Filed: Oct. 6, 2023

(51) Int. Cl. G21K 1/00

(52) U.S. Cl. CPC G21K 1/006

(57) ABSTRACT

For trapping atoms, an x-axis wire carries an x-axis current I₀cos Ωt, wherein I₀ is current amplitude, Ω is a trap field frequency, and t is time. A y-axis wire carries a y-axis current I₀sin Ωt, the y-axis wire intersecting the x-axis wire at a cross center. A β-field coil generates a transverse magnetic bias field β rotating about the cross center and perpendicular to a z axis. A γ-field coil generates a longitudinal magnetic bias field γ rotating about the cross center and perpendicular to the z axis. The x-axis wire, the y-axis wire, the transverse magnetic bias field β, and the longitudinal magnetic bias field γ form a time-averaged trap along the z axis near the cross center.

### FEDERALLY SPONSORED RESEARCH AND DEVELOPMENT

This invention was made with government support under FA9453-19-1-0007 awarded by DARPA. The government has certain rights in the invention.

### BACKGROUND INFORMATION

The subject matter disclosed herein relates to atom chip traps.

### BRIEF DESCRIPTION

An atom trap is disclosed. An x-axis wire carries an x-axis current I₀cos Ωt, wherein I₀ is current amplitude, Ω is a trap field frequency, and t is time. The atom trap further includes a y-axis wire carrying a y-axis current I₀sin Ωt, the y-axis wire intersecting the x-axis wire at a cross center. A β-field coil generates a transverse magnetic bias field β rotating about the cross center and perpendicular to a z axis. A γ-field coil generates a longitudinal magnetic bias field γ rotating about the cross center and perpendicular to the z axis. The x-axis wire, the y-axis wire, the transverse magnetic bias field β, and the longitudinal magnetic bias field γ form a time-averaged trap along the z axis near the cross center. A method and atom trap system also implement the atom trap.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope. The embodiments will be described and explained with additional specificity and detail through the use of the accompanying drawings, in which:

FIG. 1A is a schematic block diagram illustrating one embodiment of an atom trap;

FIG. 1B is a schematic block diagram illustrating one embodiment of an atom trap;

FIG. 2A is a graph illustrating one embodiment of trapping potential for an atom trap;

FIG. 2B is a graph illustrating one embodiment of trapping potential for an atom trap;

FIG. 2C is a graph illustrating one embodiment of trapping potential for an atom trap;

FIG. 2D is graph illustrating one embodiment of trap depth;

FIG. 3A is a side-view drawing illustrating one embodiment of loading an atom trap;

FIG. 3B is a side-view drawing illustrating one alternate embodiment of loading an atom trap;

FIG. 3C is a side-view drawing illustrating one alternate embodiment of loading an atom trap;

FIG. 4A is a top-view drawing illustrating one embodiment of a thin cross for an atom trap;

FIG. 4B is a top-view drawing illustrating one embodiment of a thin cross and a wide cross for an atom trap;

FIG. 4C is a bottom-view drawing illustrating one embodiment of a wide cross for an atom trap;

FIG. 5A is a top-view drawing illustrating one embodiment of an atom trap system;

FIG. 5B is a schematic block diagram illustrating one embodiment of a controller;

FIG. 6A is a flow chart diagram illustrating one embodiment of an atom trap operation method; and

FIG. 6B is a flow chart diagram illustrating one embodiment of an atom trap operation method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The description of elements in each figure may refer to elements of proceeding figures. Like numbers refer to like elements in all figures, including alternate embodiments of like elements.

An atom trap may use electric, magnetic and/or optical fields to confine and manipulate cold atoms. The flexible and accurate control of cold atom clouds and Bose-Einstein condensates (BECs) that can be achieved with atom traps makes them ideal for atom interferometry. Atom traps are used in various applications such as quantum computing, atomic clocks, and inertial sensing. In the presence of gravity, fields must be strong to hold atoms. However, in free fall, weaker fields may be employed trap the atoms.

A tighter atom trap is useful for applications like an interferometer since it would increase the speed of evaporative cooling and thus allow faster operation rates. The embodiments described herein generate a tight atom trap as will be described hereafter.

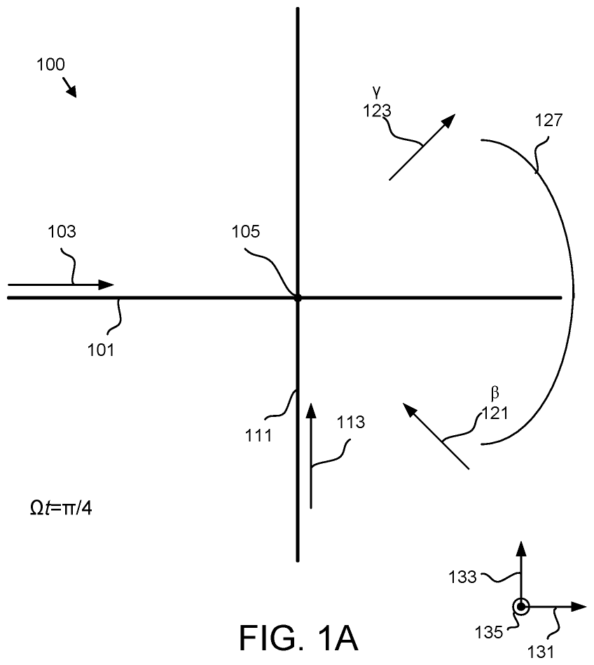

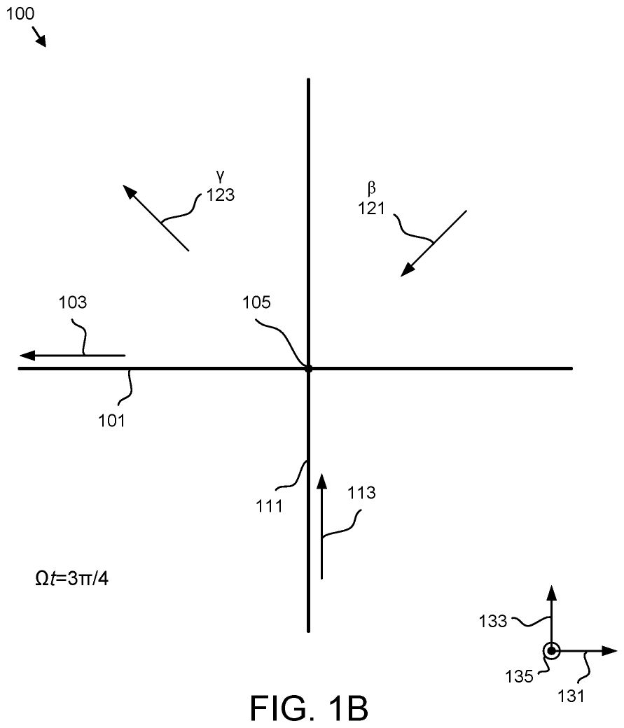

FIG. 1A is a schematic block diagram illustrating one embodiment of an atom trap 100. The atom trap 100 may be embodied on an atom chip, which is described hereafter. An x-axis 131, y-axis 133, and z-axis orthogonal to the x-axis 131 and the y-axis 133 are shown. An x-axis wire 101 and a y-axis wire 111 are disposed on a chip substrate (not shown). The x-axis wire 101 carries an x-axis current 103. The y-axis wire 111 carries a y-axis current 113. The x-axis current 103 may be I₀cos Ωt and the y-axis current 113 may be I₀sin Ωt wherein I₀ is current amplitude, Ω is a trap field frequency, and t is time. The current amplitude I₀ may be in the range of 0.2 to 100 amperes (A). The x-axis wire 101 and the y-axis wire 111 intersect at a cross center 105. The cross center 105 may be electrical common to both the x-axis wire 101 and the y-axis wire 111. In addition, direct current (dc) x-axis currents 103 and y-axis currents 113 may be employed.

A transverse magnetic bias field β 121 rotates about the cross center 105 and is perpendicular to the z axis 135. The transverse magnetic bias field β 121 may be generated by β-field conductors (not shown) which are described hereafter. A longitudinal magnetic bias field γ 123 rotates about the cross center 105 and is perpendicular to the z axis 135. The x-axis wire 101, the y-axis wire 111, the transverse magnetic bias field β 121, and the longitudinal magnetic bias field γ 123 form a time-averaged trap along the z axis 135 near the cross center 105. In the depicted embodiment, the transverse magnetic bias field β 121 and the longitudinal magnetic bias field γ 123 are shown at a time Ωt=π/4.

In one embodiment, the longitudinal magnetic bias field γ 123 is initially a π/2 offset angle 127 to the transverse magnetic bias field β 121. The offset angle 127 may be subsequently reduced to balance gravity.

In one embodiment, a dc current passing through the x-axis with a transverse magnetic bias field β 121 in the +y direction produces a line of field zeros running above the x axis 131. An additional longitudinal magnetic bias field γ 123 along the x axis 131 converts this line into a harmonic minimum, which provides confinement along the y axis 131 and z axis 135 directions but a uniform potential along the x axis 131. To generate three-dimensional confinement, the x-axis wire 101 and the y-axis wire 111 are instead driven with x-axis current 103 and y-axis current 113 oscillating at cos Ωt and sin Ωt while the transverse magnetic bias field β 121 and the longitudinal magnetic bias field γ 123 rotate in sync. The shape of the net field is not constant in time, but it approximates a rotating two-dimensional trap. As long as Ω is sufficiently large, the atoms experience the time-averaged field, which results in a three-dimensional trap.

FIG. 1B is a schematic block diagram illustrating one embodiment of an atom trap 100. The atom trap 100 of FIG. 1A is shown with the transverse magnetic bias field β 121 and the longitudinal magnetic bias field γ 123 rotated about the cross center 105 at time Ωt=3π/4. The x-axis current 103 has switched direction as specified by cos Ωt.

The transverse magnetic bias field β 121 sets the distance of the time-averaged trap from the substrate, while the longitudinal magnetic bias field γ 123 provides a non-zero bias at the center of the time-averaged trap. The transverse magnetic bias field β 121 and longitudinal magnetic bias field γ 123 rotate in sync with the oscillating x-axis current 103 and y-axis current 113. In the depicted embodiments, the atom trap 100 provides tight confinement with no intrinsic geometry scale.

For an atom trap 100 with a coordinate origin at the cross center 105, the fields involved can be expressed with Equation (1), wherein μ₀ is a permeability constant.

$$B ( t ) = \frac{{μ}_{0} {I}_{0}}{2 π} [ \frac{y \hat{z} - z \hat{y}}{{y}^{2} + {z}^{2}} cos Ω t + \frac{z \hat{x} - x \hat{z}}{{x}^{2} + {z}^{2}} sin Ω t ] + β ( \hat{y} cos Ω t - \hat{x} sin Ω t ) + γ ( \hat{x} cos Ω t + \hat{y} sin Ω t ) \qquad ( 1 )$$

The first portion gives the field from the x-axis wire 101 and y-axis wire 111, which are assumed to be long and thin. The second portion gives the bias component perpendicular to the wires, with amplitude β. The trap center will occur where the wire-generated field and the β field cancel, at a trap distance z₀ given by Equation (2).

$${z}_{0} ≡ \frac{{μ}_{0} {I}_{0}}{2 πβ} . \qquad ( 2 )$$

In one embodiment, z₀ and β are used as independent variables in the following since z₀ is experimentally significant and the combination leads to relatively simple expressions. The current amplitude may be I₀=2πβz₀/μ₀. The longitudinal magnetic bias field γ 123 provides a non-zero trap minimum. Although the decomposition shown here is convenient for analysis, the total bias can be implemented as a single rotating field given by Equation (3) with phase θ=tan⁻¹ (β/γ) relative to the x-axis current 103 and y-axis current 113.

$${B}_{b i a s} ( t ) = \sqrt{{β}^{2} + {γ}^{2}} [ \hat{x} cos ( Ω t + θ ) + \hat{y} sin ( Ω t + θ ) ] \qquad ( 3 )$$

In one embodiment, to characterize the time-averaged trap, the field components are Taylor expanded around the cross center 105, with ζ≡z−z₀. The field magnitude is thus given by Equation (4) to second order in the coordinates.

$$B ( t ) = \sqrt{{B}_{x}^{2} + {B}_{y}^{2} + {B}_{z}^{2}} \approx γ + \frac{{β}^{2}}{2 γ {z}_{0}^{2}} ( {x}^{2} {cos}^{2} Ω t + {y}^{2} {sin}^{2} Ω t + {ζ}^{2} ) - \frac{2 β}{{z}_{0}^{2}} ( {x}^{2} + xy - {y}^{2} ) sin Ω t cos Ω t \qquad ( 4 )$$

Time averaging yields the effective potential of Equation (5), where μ is the magnetic moment of the atomic state and ρ²=x²+y².

$$V ( r ) = μ 〈 B 〉 = μ γ + \frac{{μβ}^{2}}{4 γ {z}_{0}^{2}} ( {ρ}^{2} + 2 {ζ}^{2} ) \qquad ( 5 )$$

The potential is confining and cylindrically symmetric, with harmonic oscillation frequencies given by Equation (6) for atomic mass m.

$${ω}_{ρ} = \sqrt{\frac{μ {β}^{2}}{2 m γ {z}_{0}^{2}}} , {ω}_{z} = \sqrt{2} {ω}_{ρ} \qquad ( 6 )$$

The numerically calculated trap potential may be compared to the harmonic approximation derived above. The confining potential is harmonic only very near the trap center. It is possible to extend the analytical calculation to higher orders and extract the leading anharmonic terms. The fourth-order expansion may be as shown in Equation (7).

$$( 7 )$$

$$〈 B 〉 \approx γ + \frac{{β}^{2}}{4 γ {z}_{0}^{2}} \{ {ρ}^{2} + 2 {z}^{2} - \frac{2}{{z}_{0}} ( {ρ}^{2} z + {z}^{3} ) - \frac{1}{16 {z}_{0}^{2}} [ ( 20 + \frac{3 {β}^{2}}{{γ}^{2}} ) {ρ}^{4} + ( 28 + \frac{3 {β}^{2}}{{γ}^{2}} ) {x}^{2} {y}^{2} + \frac{8 {β}^{2}}{{γ}^{2}} ( x {y}^{3} - {x}^{3} y ) + 8 ( \frac{{β}^{2}}{{γ}^{2}} - 4 ) {ρ}^{2} {z}^{2} + 8 ( \frac{{β}^{2}}{{γ}^{2}} - 12 ) {z}^{4} ] \} ,$$

The anharmonic terms become important for coordinate excursions on the order of z₀ or γz₀/β, whichever is smaller.

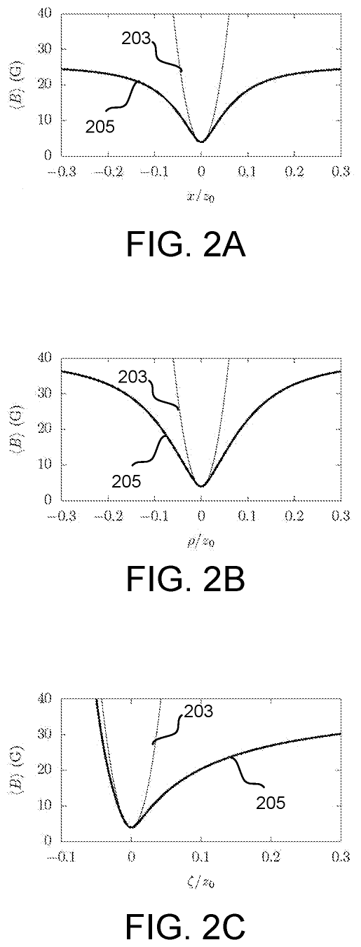

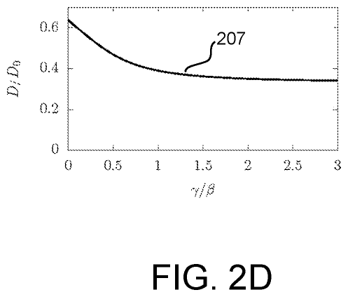

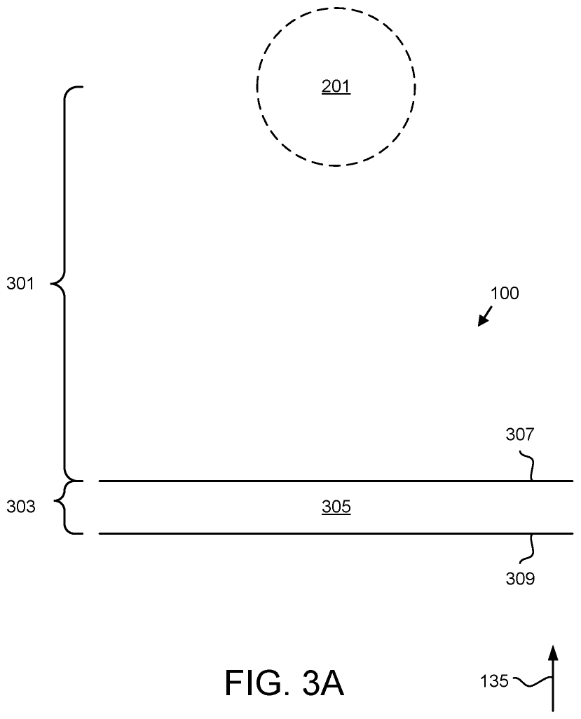

FIG. 2A is a graph illustrating one embodiment of trapping potential B for the atom trap 100. A trapping potential B measured in Gauss (G) is shown along the x axis 131. In the depicted embodiment, the parameters are current amplitude I₀=20 A, a transverse magnetic bias field 121 β=40 G, and longitudinal magnetic bias field 123 γ=4 G. These provide a potential minimum at a trap distance z₀=1 mm. A magnetic field curve 205 shows the time-averaged magnetic field magnitude and an effective potential curve 203 shows the quadratic approximation of Equation (5).

FIG. 2B is a graph illustrating one embodiment of trapping potential for an atom trap 100. The magnetic field curve 205 and effective potential curve 203 are shown along the line x=y for ρ=(x²+y²)^{1/2} with z=z₀.

FIG. 2C is a graph illustrating one embodiment of trapping potential B for an atom trap 100. The magnetic field curve 205 and effective potential curve 203 are shown along the z axis 135 with ζ=z−z₀.

As shown, there is no intrinsic geometrical length scale for the atom trap 100, since z₀ can be made as small or large as desired simply by adjusting the field and current amplitudes. In practice, however, the range of z₀ will be constrained on the large side by the length L of the x-axis wire 101 and the y-axis wire 111. The impact of finite L will depend on how current is delivered to the chip. If the current enters via long lead wires perpendicular to the atom chip, the dominant effect is that the leads contribute a field parallel to the transverse magnetic bias field β 121, which moves the trap minimum closer to the atom chip and makes the trap more confining. If the transverse magnetic bias field β 121 is reduced to keep trap distance z₀ constant, there is a modest reduction in the confinement frequencies. For L/z₀>4, the reduction is less than 10%. The range of trap distance z₀ is limited on the small side by the width w of the x-axis wire 101 and the y-axis wire 111, since the thin-wire approximation will fail. If the the x-axis wire 101 and the y-axis wire 111 are modeled as flat strips, the trap distance z₀ is reduced, the trap minimum moves closer to the atom trap 100 than z₀ and the confinement becomes weaker. Both Δz/z₀ and Δω/ω remain less than 10% down to z₀=w.

FIG. 2D is graph illustrating one embodiment of trap depth. In one embodiment, the trap depth D 207 is set by the time-averaged field above the x-axis wire 101 and the y-axis wire 111 far from the cross center 105. The trap depth D 207 cannot be expressed as a simple analytic function, but it is of order D₀≡\sqrt{β²+γ²}−γ. A numerical calculation of the trap depth D 207 is shown, where D₀=\sqrt{β²+γ²}−γ. For large γ/β, the trap depth D 207 approaches D₀/3=β²/6γ, and for γ/β→0, the trap depth D 207 approaches 2D₀/π=2β/π.

Applications such as atom interferometry can make use of a weakly confining time-averaged trap, in which case it is necessary to compensate for gravity. The atom trap 100 may achieve this by changing the relationship between the the x-axis wire 101 and the y-axis wire 111 fields and the transverse magnetic bias field β 121 and the longitudinal magnetic bias field γ 123. A convenient parametrization is via a phase ϕ in the γ field of Equation (7), making it γ[\hat{x} cos(Ωt+ϕ)+ŷ sin(Ωt+ϕ)]. In terms of the total bias field of Equation (3), this corresponds to correlated shifts in amplitude and phase |B_{bias}|→\sqrt{β²+γ²+2γβ sin ϕ} and θ→ tan⁻¹[(β+γ sin ϕ)/(γ cos ϕ)]. Re-evaluating the time-averaged field to second order yields Equation 8.

$$〈 B 〉 = γ + β sin ϕ \frac{ζ}{{z}_{0}} + ( \frac{{β}^{2}}{4 γ} + \frac{1}{2} β sin ϕ ) \frac{{ρ}^{2}}{{z}_{0}^{2}} + ( \frac{{β}^{2}}{2 γ} {cos}^{2} ϕ - β sin ϕ ) \frac{{ζ}^{2}}{{z}_{0}^{2}} \qquad ( 8 )$$

In one embodiment, the term linear in ζ can compensate for gravity g in the z axis direction by based on Equation (9), where m is the atomic mass, g is the acceleration of gravity, z₀ is the trap distance 301, and μ is the magnetic moment of the atom.

$$β sin ϕ = {mgz}_{0} / μ . \qquad ( 9 )$$

In one embodiment, modeling a case where the longitudinal magnetic bias field γ rotation rate is different from Ω, by setting phase ϕ=Δt for constant Δ. We then have [symbol] sin ϕ [symbol] →0 and [symbol] cos²ϕ [symbol] →1/2, leading to a spherically symmetric trap with isotropic frequency ω²=μβ²/(2mγz₀²). One way to achieve this is with Δ=−Ω, corresponding to a static longitudinal magnetic bias field γ 123 pointing in any direction parallel to the x-axis wire 101 and the y-axis wire 111.

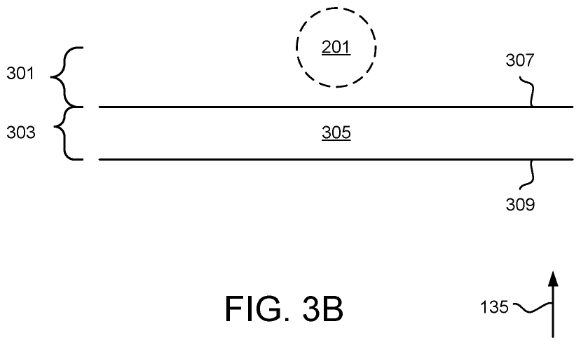

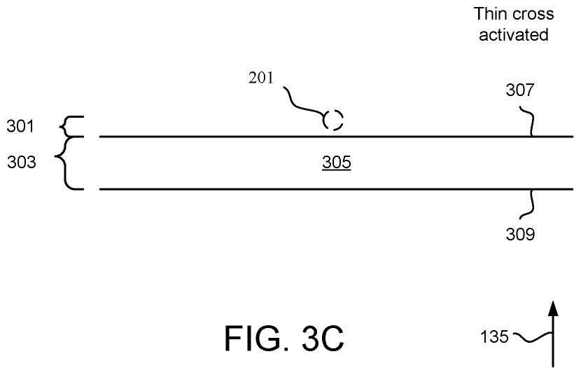

FIG. 3A is a side-view drawing illustrating one embodiment of loading an atom trap 100. A substrate 305 comprising the atom trap 100 on the substrate surface. In one embodiment, a thin x-axis wire 101a and a thin y-axis wire 111a form a thin cross and a wide x-axis wire 101b and a wide y-axis wire 111b form a wide cross. A plurality of thin crosses and wide crosses may be employed. The thin cross may be disposed on a dorsal side 307 and the wide cross may be disposed on ventral side 309.

In one embodiment, the atom trap 100 captures atoms from a magneto-optical trap (MOT) located several mm from the substrate 305, and then compresses the atoms to the atom trap 100 with confinement frequencies above 1 kHz for evaporative cooling. The atom trap 100 may be fabricated from 100-μm thick direct-bonded copper x-axis and y-axis wires 101/111 on an aluminum-nitride substrate 305. The dorsal side 307 of the substrate 305 facing the atoms is patterned to produce x-axis and y-axis wires 101/111 that are 100 μm wide. The ventral side 309 may have a matching cross pattern with x-axis and y-axis wires 101/111 that are 3 mm wide. The substrate chip size L may be 3 cm and the substrate thickness may be 1 mm.

In one embodiment, the wide cross is used to produce a distant trap 201 for loading. Using a current amplitude I₀=75 A, bias fields β=20 G, γ=2 G, and a phase ϕ=0.85 rad, the resulting time-averaged trap 201 is approximately a 7 mm trap distance z₀ 301 from the substrate 305. For ⁸⁷Rb atoms in the F=2, m_{F}=2, Zeeman state where μ is equal to the Bohr magneton, this trap 201 provides support against gravity and confinement frequencies ω_{ρ}≈2π×18 Hz and ω_{z}≈2π×13 Hz, with a trap depth of 12 G. These are appropriate values for direct loading from a MOT. The total power consumption on the atom trap 100 is about 10 W, which is well within the capacity of the substrate 305.

FIG. 3B is a side-view drawing illustrating one alternate embodiment of loading the atom trap 100. Once the trap 201 of FIG. 3A is loaded, currents 103/113 through the wide cross may be adiabatically decreased, which reduces the trap distance z₀ 301 and compresses the trap 201.

FIG. 3C is a side-view drawing illustrating one alternate embodiment of loading the atom trap 201. Once the atoms are within a few mm trap distance z₀ 301 of the substrate 305 as shown in FIG. 3B, the current is adiabatically shunted to the thin cross, supporting a smaller trap distance z₀ 301. A current of 5 A and bias fields β=40 G, γ=2 G would generate a time-averaged trap 201 approximately 0.25 mm from the substrate 305 with ω_{ρ}≈2π×1 kHz and ω_{z}≈2π×1.4 kHz. This makes a suitable trap 201 for rapid evaporative cooling. Power dissipation on the substrate 305 would be about 1 W. If a two-layer substrate 305 as described here is undesirable, another way to support a wide range of trap distance z₀ values is with tapered x-axis and y-axis wires 101/111 whose widths decrease as they approach the cross center 105. The trap 201 is far enough from the substrate 305 that roughness of the x-axis and y-axis wires 101/111 and other surfaces effects are not significant.

The trap field frequency Ω must be large compared to the highest confinement frequency of the trap 201, ωₘ, so that atom motion is negligible during the period 2π/Ω. The frequency ωₘ must also be small compared to the Larmor frequency≈μ_{B}γ/ℏ, so that the bias fields 121/123 do not drive spin transitions. In one embodiment, trap field frequencies Ω are on the order of 10 kHz, while typical confinement frequencies are on the order of 100 Hz. Because the atom trap 100 can achieve confinement frequencies above 1 kHz, it may be necessary to use a correspondingly greater range of frequencies.

In one embodiment, Ω/ωₘ≳5 may be sufficient. A 1.4 kHz chip trap as described above may use a trap field frequency below 30 kHz, and perhaps as low as 7 kHz. At a bias field 121/123 of 2 G, the Larmor frequency for ⁸⁷Rb is 1.4 MHZ, so the parameters proposed here do not approach the high frequency limit.

Two driver circuits may supply the x-axis current 103 and the y-axis current 113. Since the x-axis wire 101 and y-axis wire 111 intersect, the two driver circuits may float with respect to ground, or each driver circuit may be balanced so that the the x-axis wire 101 and y-axis wire 111 at the cross center 105 are at a common ground potential. Isolation transformers may be employed to maintain the common ground potential. The isolation transformers may be efficient and stable at frequencies in the range of 1 kHz and higher.

In one embodiment, the three-dimensional time-averaged trap 201 is adiabatically converted to a two-dimensional guide. This can be achieved by reducing the current through one of the x-axis wire 101 or y-axis wire 111 to zero along with the corresponding component of the transverse magnetic bias field β 121. For a guide along the x axis 131, the resulting transverse magnetic bias field β 121 is given by Equation (10) with z₀=μ₀I₀/2πβ for chip current amplitude I₀.

$$B ( t ) = β cos Ω t [ \hat{y} + \frac{{z}_{0} ( y \hat{z} - z \hat{y} )}{{y}^{2} + {z}^{2}} ] + γ ( \hat{x} cos Ω t + \hat{y} sin Ω t ) \qquad ( 10 )$$

The time-averaged transverse magnetic bias field β 121 and longitudinal magnetic bias field γ 123 has the form given in Equation (11), with ζ=z−z₀, and thus provides harmonic confinement with ω_{y}²=μβ²/(2γz₀²) and ω_{z}=(\sqrt{3}/2)ω_{y}.

$$〈 B 〉 = γ + \frac{{β}^{2}}{4 γ {z}_{0}^{2}} ( {y}^{2} + \frac{3}{4} {ζ}^{2} ) \qquad ( 11 )$$

For example, if β=40 G, γ=2 G and I=5 A as in the trap 201 of FIG. 3C, the guide distance remains at 0.25 mm and the confinement frequencies for ⁸⁷Rb are about 1 kHz and 800 Hz. Power dissipation on the substrate 305 is reduced by a factor of two compared to the equivalent trap 201. The guide potential can again be modified to support gravity by introducing a phase ϕ to the γ field as in Equation (8), resulting in Equation (12).

$$〈 B 〉 = γ + \frac{1}{2} β sin ϕ \frac{ζ}{{z}_{0}} + ( \frac{{β}^{2}}{4 γ} + \frac{1}{2} β sin ϕ ) \frac{{y}^{2}}{{z}_{0}^{2}} + [ \frac{{β}^{2}}{16 γ} ( 1 + 2 {cos}^{2} ϕ ) - \frac{1}{2} β sin ϕ ] \frac{{ζ}^{2}}{{z}_{0}^{2}} . \qquad ( 12 )$$

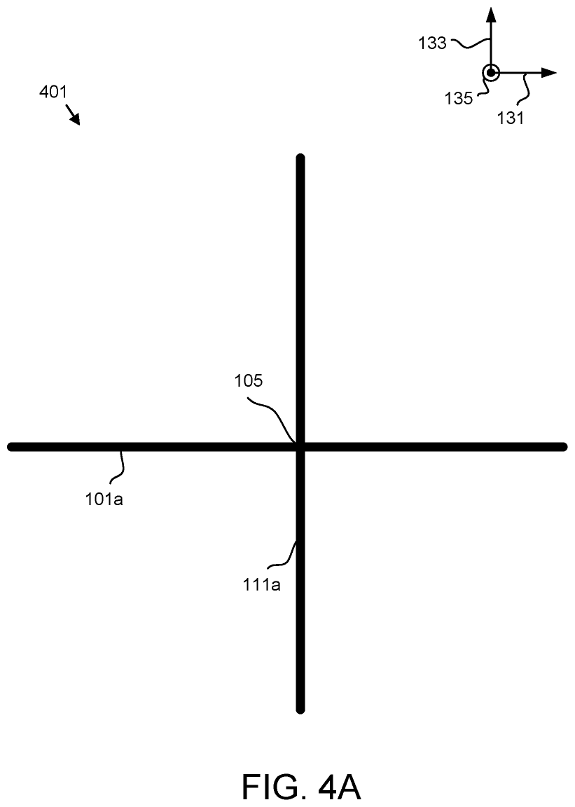

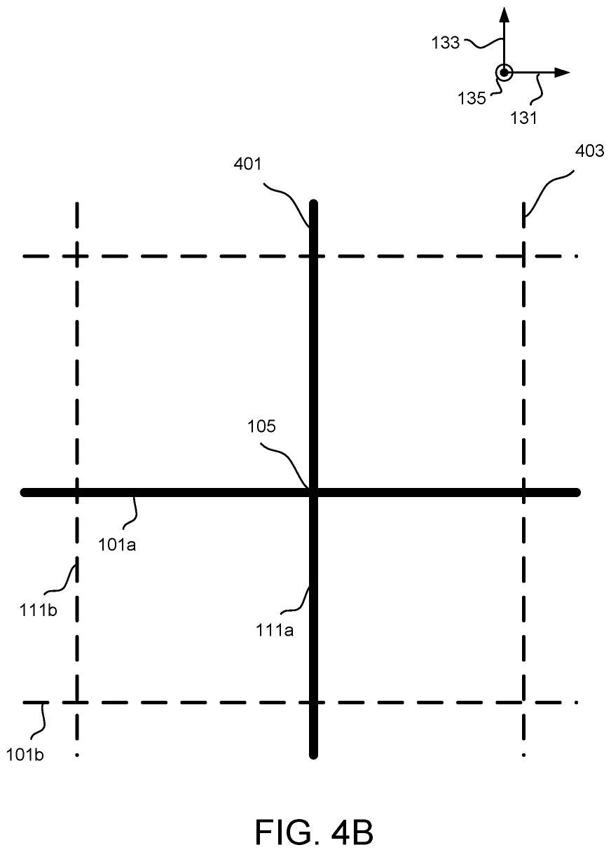

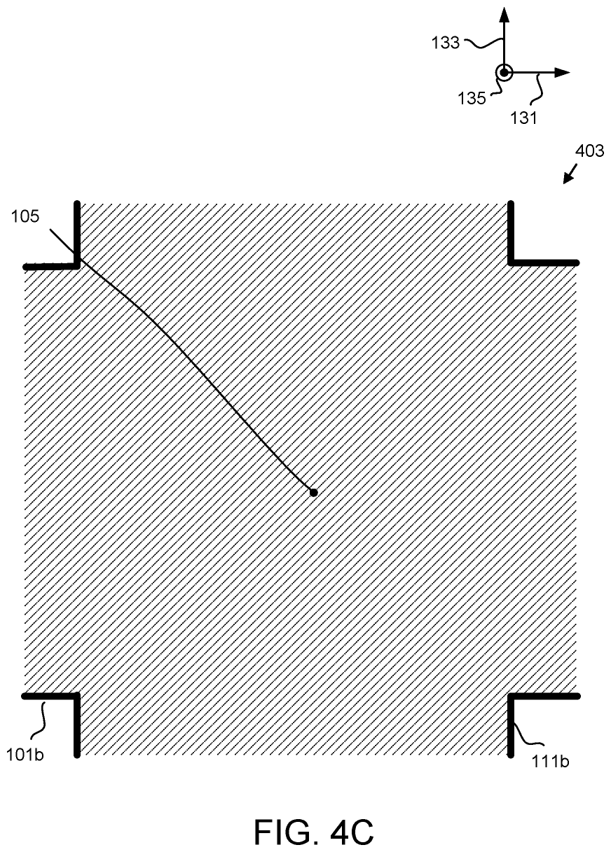

FIG. 4A is a top-view drawing illustrating one embodiment of a thin cross 401 for an atom trap 100. A thin x-axis wire 101a and a thin y-axis wire 111a form the thin cross 401. The thin cross 401 may be disposed on the dorsal side 307 of the substrate 305. A thin x-axis current 103a and a thin y-axis current 113a are carried by the thin x-axis wire 101a and the thin y-axis wire 111a respectively.

FIG. 4B is a top-view drawing illustrating one embodiment of a thin cross 401 and a wide cross 403 for an atom trap 100. The thin cross 401 of FIG. 4A is shown. The thin x-axis wire 101a and the thin y-axis wire 111a of the thin cross 401 are disposed on the dorsal side 307. In addition, the edges of the wide x-axis wire 101b and the wide y-axis wire 111b of the wide cross 403 disposed on the ventral side 309 are shown as broken lines, illustrating the relative positions of the thin cross 401 and the wide cross 403 along the z axis 135.

FIG. 4C is a bottom-view drawing illustrating one embodiment of a wide cross 403 for the atom trap 100. The wide x-axis wire 101b and the wide y-axis wire 111b are shown, with the wide x-axis wire 101b and the wide y-axis wire 111b joined at the cross center 105. A wide x-axis current 103b and a wide y-axis current 113b are carried by the wide x-axis wire 101b and the wide y-axis wire 111b respectively.

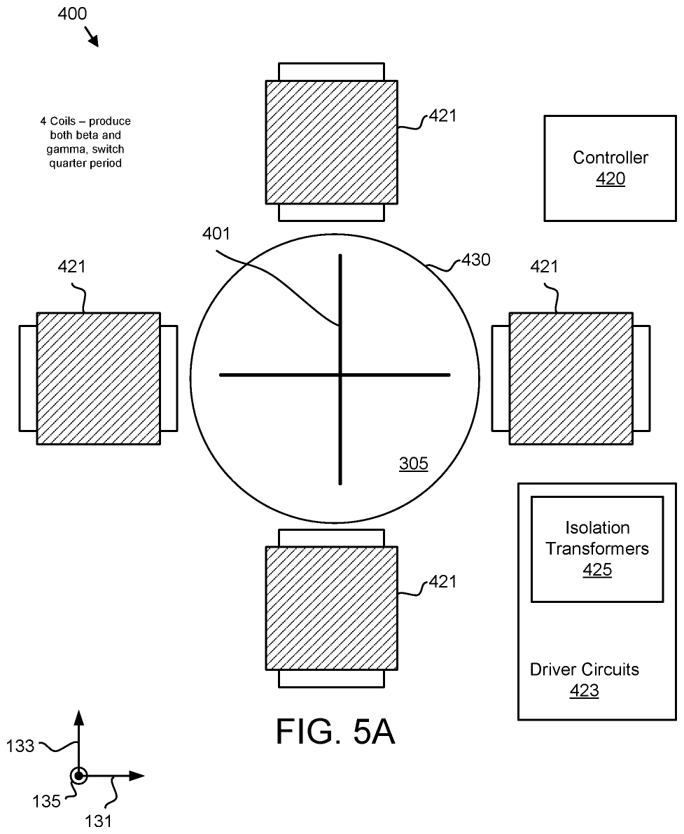

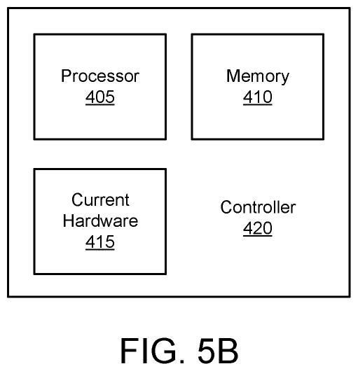

FIG. 5A is a top-view drawing illustrating one embodiment of an atom trap system 400. In the depicted embodiment, the thin cross 401 is disposed on the substrate 305 of an atom chip 430. At least two coils 421 are disposed around the atom chip 430. In the depicted embodiment, four coils 421 are employed. The coils 421 may comprise β-field conductors and/or γ-field conductors. The coils 421 generate the transverse magnetic bias field β 121 and/or the longitudinal magnetic bias field γ 123. In one embodiment, a single set of coils 421 generate both the transverse magnetic bias field β 121 and the longitudinal magnetic bias field γ 123. In an alternate embodiment, separate coils 421 generate the transverse magnetic bias field β 121 and the longitudinal magnetic bias field γ 123. In one embodiment, the coils 421 switch each quarter period.

A controller 420 may control the transverse magnetic bias field β 121 and the longitudinal magnetic bias field γ 123 by controlling current to the coils 421. In addition, the controller 420 may control the x-axis currents 103 and the y-axis currents 113 by controlling the driver circuits 423. The driver circuits 423 may comprise isolation transformers 425. In one embodiment, parameters for the atom trap system 400 have ranges as shown in Table 1.

TABLE 1

| | | |
|---|---|---|
| Parameter | Minimum | Maximum |

| | | | | |
|---|---|---|---|---|
| current amplitude I₀ | 0.2 | A | 100 | A |
| transverse magnetic bias field | 1.5 | G | 50 | G |
| β 121 | | | | |
| longitudinal magnetic bias | 0.5 | G | 50 | G |
| field γ 123 | | | | |
| Phase | 0.0 | rad | 1.5 | rad |
| thin x-axis wire width | 7.5 | μm | 250 | μm |
| thin y-axis wire width | 7.5 | μm | 250 | μm |
| wide x-axis wire width | 0.25 | mm | 3.5 | mm |
| wide y-axis wire width | 0.25 | mm | 3.5 | mm |

FIG. 5B is a schematic block diagram illustrating one embodiment of the controller 420 of FIG. 5A. In the depicted embodiment, the controller 420 includes a processor 405, a memory 410, and current hardware 415. The memory 410 may store code. The processor 405 may execute the code to control currents via the current hardware 415.

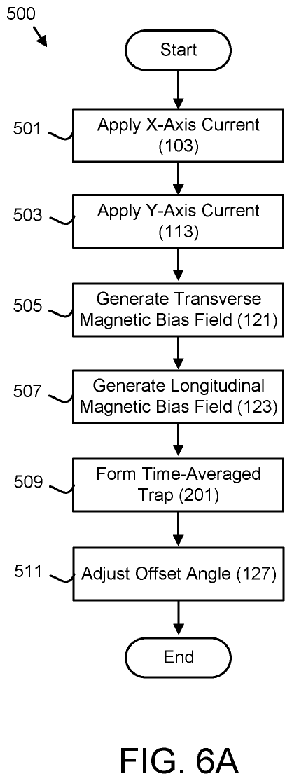

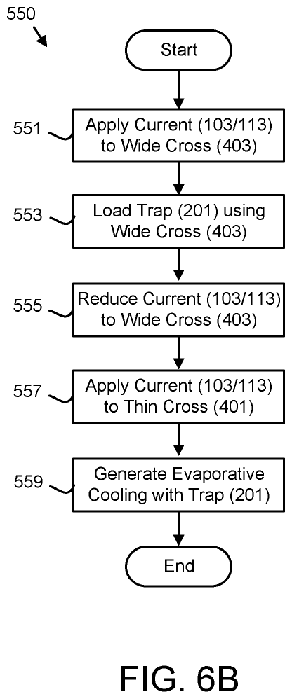

FIG. 6A is a flow chart diagram illustrating one embodiment of an atom trap operation method 500. The method 500 traps atoms in a magnetic field. The method 500 may be performed with the atom trap 100 and/or atom trap system 400.

The atom trap 100 applies 501 an x-axis current 103 to the x-axis wire 101. The atom trap further applies 503 the y-axis current 113 to the y-axis wire 111. The atom trap 100 generates 505 the transverse magnetic bias field β 121 rotating about the cross center 105 and perpendicular to the z axis 135. In addition, the atom trap 100 generates 507 the longitudinal magnetic bias field γ 123 rotating about the cross center 105 and perpendicular to the z axis 135. The x-axis wire 101, the y-axis wire 111, the transverse magnetic bias field β 121, and the longitudinal magnetic bias field γ 123 form 509 a time-averaged trap 201 along the z axis 135 near the cross center 105.

In one embodiment, the atom trap 100 adjusts 511 the offset angle φ 127 to compensate for gravity and the Method 500 ends. The offset angle φ 127 may be selected to satisfy Equation (9).

FIG. 6B is a flow chart diagram illustrating one embodiment of an atom trap operation method 550. The method 550 traps atoms in magnetic field. In addition, the method 550 may perform evaporative cooling with the trapped atoms. The method 550 may be performed with the atom trap 100 and/or atom trap system 400.

The method 550 starts and in one embodiment, the atom trap 100 applies 551 the x-axis current 103 and the y-axis current 113 to the wide x-axis wire 101b and the wide y-axis wire 111b of the wide cross 403. In addition, the coils 421 generate the transverse magnetic bias field β 121 and the longitudinal magnetic bias field γ 123.

The wide x-axis wire 101b and the wide y-axis wire 111b of the wide cross 403, along with the transverse magnetic bias field β 121, and the longitudinal magnetic bias field γ 123 form a time-averaged trap 201 along the z axis 135 near the cross center 105 that loads 503 the trap 201 with atoms as shown in FIG. 3A.

The atom trap 100 reduces 555 the x-axis current 103 and the y-axis current 113 to the wide x-axis wire 101b and the wide y-axis wire 111b respectively of the wide cross 403 as shown in FIG. 3B. As a result, the trap 201 is positioned nearer to the substrate 305 of the atom trap 100.

The atom traps 100 applies 557 the x-axis current 103 and the y-axis current 113 to the thin x-axis wire 101a and the thin y-axis wire 111a of the thin cross 401. The thin x-axis wire 101a and the thin y-axis wire 111a of the thin cross 401, along with the transverse magnetic bias field β 121, and the longitudinal magnetic bias field γ 123 continue generating the time-averaged trap 201 as shown in FIG. 3C. In one embodiment, the atoms in the time-average trap 201 are used to generate 559 evaporative cooling and the method 550 ends.

In summary, the atom trap 100 provides a chip-based atom trap 100 with confinement comparable or better than that of the prior art. The confinement is naturally cylindrically symmetric and can be readily modified to be spherically symmetric and to provide support against gravity. The trap center can be positioned further from the substrate 305 than is possible with conventional approaches, and the same chip geometry can provide a two-dimensional atom guide. These features will make the atom trap 100 useful for a variety of applications. One example is the atomic Sagnac interferometers, where the atom trap 100 could significantly simplify the apparatus and allow faster production of Bose condensates, thus increasing the sensing bandwidth. For this purpose, the cylindrical symmetry of the trap 201 is critical. Embodiments may be employed to produce bias fields with the chip substrate 305 itself, and thereby remove the need for external coils 421. The embodiments facilitate the use of ultracold atom techniques in practical applications.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An atom trap comprising:
an x-axis wire carrying an x-axis current I₀cos Ωt, wherein I₀ is current amplitude, Ω is a trap field frequency, and t is time;
a y-axis wire carrying a y-axis current I₀sin Ωt, the y-axis wire intersecting the x-axis wire at a cross center;
a β-field coil generating a transverse magnetic bias field β rotating about the center point and perpendicular to a z axis;
a γ-field coil generating a longitudinal magnetic bias field γ rotating about the center point and perpendicular to the z axis; and
wherein the x-axis wire, the y-axis wire, the transverse magnetic bias field β, and the longitudinal magnetic bias field γ form a time-averaged trap along the z axis near the cross center.

2. The atom trap of claim 1, wherein the β-field coil and the γ-field coil are a single coil.

3. The atom trap of claim 1, wherein an x-axis driver circuit provides the x-axis current, a y-axis driver circuit provides the y-axis current, the x-axis driver circuit and the y-axis driver circuit float with respect to ground, and the x-axis driver circuit and the y-axis driver circuit maintain the center point at a common ground potential.

4. The atom trap of claim 1, wherein the current amplitude I₀=2πβz₀/μ₀, a trap distance
$${z}_{0} ≡ \frac{{μ}_{0} {I}_{0}}{2 πβ} .$$
and μ₀ is a permeability constant.

5. The atom trap of claim 1, wherein the trap field frequency Ω is greater than 1 kHz.

6. The atom trap of claim 1, wherein the current amplitude I₀ is in the range of 0.2 to 100 amperes (A).

7. The atom trap of claim 1, wherein the longitudinal magnetic bias field γ is initially a π/2 offset angle to the transverse magnetic bias field β and the offset angle is subsequently reduced to balance gravity.

8. The atom trap of claim 1, wherein the x-axis wire is a thin x-axis wire and the y-axis wire is a thin y-axis wire that form a thin cross and a wide x-axis wire and a wide y-axis wire form a wide cross.

9. The atom trap of claim 8, wherein the thin cross and the wide cross are disposed on opposite sides of a substrate.

10. The atom trap of claim 9, wherein the wide cross loads atoms into the atom trap, current is reduced from the wide cross and increased to the thin cross to complete loading and generate evaporative cooling.

11. The atom trap of claim 9, wherein the thin cross and the wide cross are fabricated from direct bonded copper and the substrate is aluminum-nitride.

12. The atom trap of claim 1, wherein parameters are in the ranges of:

| | | |
|---|---|---|
| Parameter | Minimum | Maximum |
| | | | | |
|---|---|---|---|---|
| current amplitude I₀ | 0.2 | A | 100 | A |
| transverse magnetic bias field | 1.5 | G | 50 | G |
| β 121 | | | | |
| longitudinal magnetic bias | 0.5 | G | 50 | G |
| field γ 123 | | | | |
| Phase | 0.0 | rad | 1.5 | rad |
| thin x-axis wire width | 7.5 | μm | 250 | μm |
| thin y-axis wire width | 7.5 | μm | 250 | μm |
| wide x-axis wire width | 0.25 | mm | 3.5 | mm |
| wide y-axis wire width | 0.25 | mm | 3.5 | mm |

13. A method comprising:
applying an x-axis current I₀cos Ωt to an x-axis wire, wherein I₀ is current amplitude, Ω is a trap field frequency, and t is time;
applying a y-axis current I₀sin Ωt to a y-axis wire, the y-axis wire intersecting the x-axis wire at a cross center;
generating a transverse magnetic bias field β rotating about the center point and perpendicular to the z axis;
generating a longitudinal magnetic bias field γ rotating about the center point and perpendicular to the z axis; and
wherein the x-axis wire, the y-axis wire, the transverse magnetic bias field β, and the longitudinal magnetic bias field γ form a time-averaged trap along the z axis near the cross center.

14. The method of claim 13, the method further comprising:
applying the x-axis current and the y-axis current to a wide x-axis wire and a wide y-axis wire respectively of a wide cross, wherein the wide x-axis wire, the wide y-axis wire, the transverse magnetic bias field β, and the longitudinal magnetic bias field γ load the time-averaged trap along the z axis near the cross center;
reducing the x-axis current and the y-axis current to the wide x-axis wire and the wide y-axis wire of the wide cross; and
applying the x-axis current and the y-axis current to the x-axis wire and the y-axis wire, wherein the x-axis wire and the y-axis wire are a thin x-axis wire and a thin y-axis wire respectively, and form a thin cross, wherein the thin x-axis wire, the thin y-axis wire, the transverse magnetic bias field β, and the longitudinal magnetic bias field γ generate the time-averaged trap along the z axis near the cross center.

15. The method of claim 14, the method further comprising generating evaporative cooling using the atoms in the time-average trap.

16. The method of claim 14, wherein the transverse magnetic bias field β and the longitudinal magnetic bias field γ are generated with a single coil.

17. The method of claim 14, wherein an x-axis driver circuit provides the x-axis current, a y-axis driver circuit provides the y-axis current, the x-axis driver circuit and the y-axis driver circuit float with respect to ground, and the x-axis driver circuit and the y-axis driver circuit maintain the center point at a common ground potential.

18. The method of claim 14, wherein the trap field frequency Ω is greater than 1 kHz.

19. An atom trap system comprising:
a thin cross comprising a thin x-axis wire carrying an x-axis current I₀cos Ωt, wherein I₀ is current amplitude, Ω is a trap field frequency, and t is time, and a thin y-axis wire carrying a y-axis current I₀sin Ωt, the y-axis wire intersecting the x-axis wire at a thin cross center;
a wide cross comprising a wide x-axis wire carrying the x-axis current and a wide y-axis wire carrying the y-axis current, the wide y-axis wire intersecting the wide x-axis wire at a wide cross center;
a coil generating a transverse magnetic bias field β rotating about the center point and perpendicular to the z axis;
the coil generating a longitudinal magnetic bias field γ rotating about the center point and perpendicular to the z axis; and
wherein the wide x-axis wire, the wide y-axis wire, the transverse magnetic bias field β, and the longitudinal magnetic bias field γ load a time-averaged trap along the z axis near the thin cross center, the x-axis current and the y-axis current are reduced to the wide cross and applied to the thin cross to maintain the time-average trap with the thin cross.

20. The atom trap system of claim 19, the atom trap system further generating evaporative cooling using the atoms in the time-average trap.
